(19) United States
(12) Patent Application Publication
(10) Pub. No.: US 2016/0165372 A1
(43) Pub. Date: Jun. 9, 2016

(54) EXCESSIVE VOICE VOLUME ALERTING

(71) Applicant: Lenovo (Singapore) Pte. Ltd., Singapore (SG)

(72) Inventors: Arnold S. Weksler, Raleigh, NC (US); Russell Speight VanBlon, Raleigh, NC (US); Neal Robert Caliendo, JR., Raleigh, NC (US)

(21) Appl. No.: 14/562,317

(22) Filed: Dec. 5, 2014

(51) Int. Cl. H04R 29/00; G08B 6/00; H04M 1/00; G08B 3/00

(52) U.S. Cl. CPC H04R 29/00; G08B 3/00; G08B 6/00; H04M 1/00

(57) ABSTRACT

A method includes detecting via a phone, a volume level of a user's voice while using the phone, comparing via the phone whether the volume level of the user's voice exceeds a specified threshold, and providing an indication to the user via the phone when the volume level exceeds the specified threshold.

### BACKGROUND

Users talking into phones, such as mobile phones, speaker phones, cellular phones, or land line phones tend to increase their voice volume and may disturb others around them. It can be particularly disturbing to other in restaurants and in open or cubicle based office spaces without full walls to block sound.

### SUMMARY

A method includes detecting via a phone, a volume level of a user's voice while using the phone, comparing via the phone whether the volume level of the user's voice exceeds a specified threshold, and providing an indication to the user via the phone when the volume level exceeds the specified threshold.

A machine readable storage device has instructions for execution by a processor of a machine. The instruction include instructions to perform detecting via the phone, a volume level of a user's voice while using a phone, detecting a volume level of ambient sound, comparing the difference between the volume level of the user's voice and the volume level of ambient sound, and providing an indication to the user when the difference exceeds a specified threshold.

A device includes a processor and a memory device having a program stored thereon for execution by the processor to receive a volume level of a user's voice while using a phone, receive a volume level of ambient sound, compare the difference between the volume level of the user's voice and the volume level of ambient sound, and provide an indication to the user when the difference exceeds a specified threshold.

### BRIEF DESCRIPTION OF THE DRAWINGS

FIG. 1 is a block diagram of a communication device that provides feedback to users speaking too loudly into the device according to an example embodiment.

FIG. 2 is a flowchart of a method of providing feedback to users speaking into a device according to an example embodiment.

FIG. 3 is a block diagram of computer system used to implement methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Conventional land line based phones provide sound feedback to a user of the phone. The sound feedback increases volume as the spoken voice volume increases. Ambient noise may drown out the feedback. Cell phones and speaker phones do not provide sound feedback, leading users to sometimes speak more loudly than they need to in order to be heard, possibly disturbing other people nearby. Voice over IP applications may provide a visual indicator of voice volume, but they simply indicate all input, including ambient noise, so a user does not receive an accurate sense of the relative volume of their voice compared to ambient noise.

In various embodiments, a speaker's voice is monitored and feedback is provided when the volume of the speaker's voice exceeds a certain level, or if it exceeds the volume relative to ambient noise. In some embodiments, the presence of other people nearby may be detected and a more aggressive volume detection used in such presence. Feedback regarding the voice exceeding the certain level may be in the form of haptic, sound, or voice feedback. The voice feedback may be a sound, word, or phrase. A beep or sound similar to the loud sound heard when a microphone and speaker combination result in too much feedback. The sound may be provided with a volume that is proportional to the user's voice volume in some embodiments.

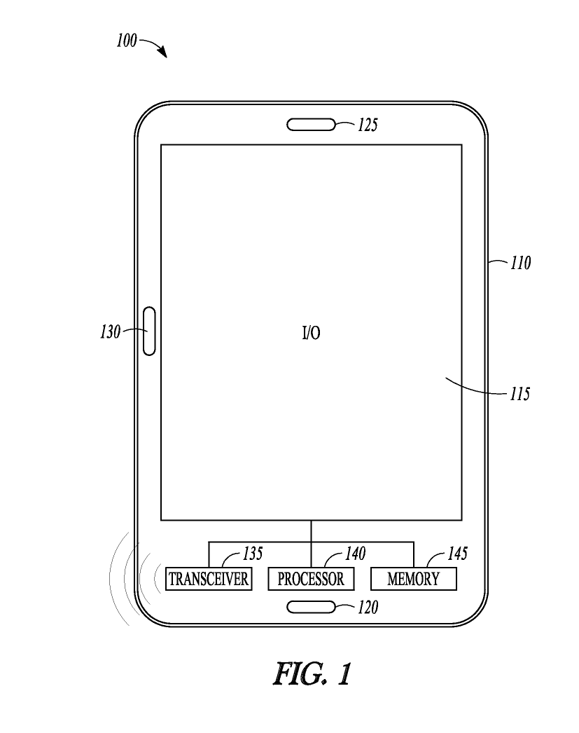

FIG. 1 is a block diagram of a mobile device 100 with voice capabilities. Device 100 comprises a housing 110 which may be in the form of a touchpad, cell phone, smart phone, lap top computer, or other computing device with voice capabilities. A data entry device 115 may be a touch screen or keypad in various embodiments. A primary microphone 120 may be supported by the housing separate from a speaker 125. The microphone 120 and speaker 125 may be positioned to optimize use as a voice communication device, such as on opposite ends of the housing 110, or otherwise for devices larger housings.

In one embodiment, primary microphone 120 is a noise cancelling microphone, such as a differential microphone utilizing two ports through which sound enters. A front port may be oriented toward the user's mouth, and a second port positioned distant from the user's mouth. Ambient sound may reach both ports at the same time. Sound originating closer to the front port provides a greater pressure gradient, causing a transducing diaphragm to move more than the ambient noise, which is provided to both sides of the diaphragm via the front port and the second port, to effectively cancel the effect of the ambient noise on the transducing diaphragm. A further diaphragm may be used in the microphone to measure the ambient noise levels.

Even of a noise canceling microphone is not used, the volume level of ambient sound or noise may be determined when a user is not talking in some embodiments. A significant increase in sound levels may be used to determine when a user is talking versus not talking to enable the measurement of the volume of ambient sound. Speech recognition may also be utilized to correlate voice volume levels and ambient sound levels. If speech is recognized, the user is likely talking, and if speech is not recognized, the user is likely not talking, allowing measurement of the ambient sound levels during such times the user is not talking.

In a further embodiment, a second microphone 130 may be positioned separate from the primary microphone in a manner conducive to picking up ambient sound levels. The second microphone 130 may be on an opposite side of the housing from the primary microphone, and also located distant from the speaker 125.

The mobile device 100 may include a transceiver 135, processor 140, and memory 145 with programming for the processor to place, receive, and conduct phone calls. The primary microphone 120 transduces the user's voice and provides digital signals representative of the sound, including volume to the processor. The digital signals may include background ambient sound or noise, which may also or alternatively provided by the second microphone 130. The processor is programmed to determine a decibel difference between the user's voice and the ambient sound and determine whether the difference exceeds a threshold. The threshold may be two or three dB in various embodiments, and may also be optionally set by the user for narrower or wider ranges. In one embodiment, the processor simply determines the overall volume of the user's voice, and compares that to a threshold.

If the user's voice level exceeds the threshold, the user may be provided feedback indicating the same. The feedback may be haptic, sound, or visual in various embodiments, and may increase in intensity, such as volume, vibration, or brightness corresponding to the amount the threshold is exceeded. In some embodiments, the feedback is provided simply as a function of the user exceeding the threshold at any point in time. In further embodiments, the threshold may be exceeded for a set time, such as two or three seconds, or may be based on several instances of exceeding the threshold over a specified period of time or an integration of the difference over time. The time and number parameters for exceeding the threshold may be set by a user or default to factory settings in different embodiments.

In still further embodiments, the processor may be programmed to record the user's voice and provide the recorded user's voice back to the user as the audible sound at a volume proportional to the difference in volume between the volume level of the user's voice and the volume level of ambient sound. The playback of the user's voice may be perceived as simultaneous by the user speaking.

In a further embodiment, the processor may be programmed to detect voices in the same location as the phone and they reduce the specified threshold as a function of the detected voices. Reducing the threshold in this manner ensures that people near the phone user are even less likely to be inconvenienced by a user of a phone.

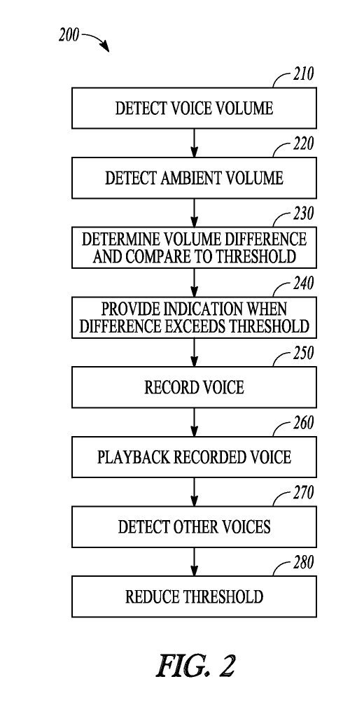

FIG. 2 is a flowchart illustrating a method 200 of alerting a user to the uses of excessive sound levels of their voice while using the device 100. The method may be implemented by a processor executing a program, or in some embodiments, a specific circuit may be used to perform the method. At 210, a volume level of a user's voice while using a phone is detected via a phone microphone. A volume level of ambient sound may also be detected at 220 via the same microphone, or a separate microphone of the phone. At 230, the difference between the volume level of the user's voice and the volume level of ambient sound is compared to a specified threshold. This comparison is equivalent to adding the volume level of ambient sounds to the specified threshold prior to determining if the volume level of the user's voice exceeds the threshold. In some embodiments, the ambient sound is set to zero such that the difference is simply the volume level of the user's voice. At 240, an indication to the user is provided when the difference exceeds the specified threshold.

In one embodiment, the specified threshold comprises 2 dB. The indication may be an audible sound such as words, or a feedback tone, such as a tone similar to the tone heard when using a microphone too close to a speaker. The feedback tone may increase in volume with an increase in the difference. Haptic feedback may be provided in further embodiments.

In a further embodiment, as indicated at 250, the user's voice may be recorded and at 260 the recorded user's voice back is provided or played back to the user as the audible sound at a volume proportional to the difference in volume between the volume level of the user's voice and the volume level of ambient sound.

In a further embodiment, method 200 further includes detecting voices in the same location as the phone at 270, and reducing the specified threshold as a function of the detected voices at 280. For example, if the specified threshold is three dB, and then voices are detected in the background, the threshold may be lowered to two dB. The threshold values references in the example are merely example thresholds, and may be varied significantly, and may be set either manually by the user or via factory settings.

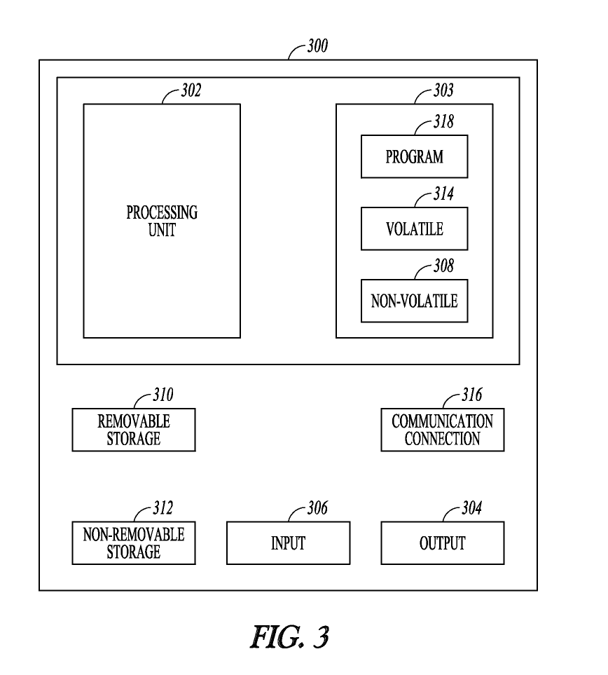

FIG. 3 is a block schematic diagram of a computer system 300 to implement methods performed by the device 100 according to example embodiments. All components need not be used in various embodiments. One example computing device in the form of a computer 300, may include a processing unit 302, memory 303, removable storage 310, and non-removable storage 312. Sensors 115 and 125 may be coupled to provide data to the processing unit 302. Memory 303 may include volatile memory 314 and non-volatile memory 308. Computer 300 may include—or have access to a computing environment that includes—a variety of computer-readable media, such as volatile memory 314 and non-volatile memory 308, removable storage 310 and non-removable storage 312. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 300 may include or have access to a computing environment that includes input 306, output 304, and a communication connection 316. Output 304 may include a display device, such as a touchscreen, that also may serve as an input device. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the processing unit 302 of the computer 300. A hard drive, CD-ROM, and RAM are some examples of articles including a non-transitory computer-readable medium such as a storage device. The terms computer-readable medium and storage device do not include carrier waves. For example, a computer program 318 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 300 to provide generic access controls in a COM based computer network system having multiple users and servers.

### Examples

1. A method comprising:

detecting via a phone, a volume level of a user's voice while using the phone;

comparing via the phone whether the volume level of the user's voice exceeds a specified threshold; and

providing an indication to the user via the phone when the volume level exceeds the specified threshold.

2. The method of example 1 and further comprising:

detecting a volume level of ambient sound; and

wherein comparing whether the volume level of the user's voice exceeds a specified threshold includes adding the volume level of ambient sound to the threshold.

3. The method of any of examples 1-2 wherein the indication comprises an audible sound.

4. The method of example 3 wherein the audible sound comprises words.

5. The method of any of examples 3-4 wherein the audible sound comprises a feedback tone.

6. The method of example 5 wherein the feedback tone increases in volume with an increase in the difference.

7. The method of any of examples 3-6 and further comprising recording the user's voice and providing the recorded user's voice back to the user as the audible sound at a volume proportional to the difference in volume between the volume level of the user's voice and the volume level of ambient sound.

8. The method of any of examples 1-7 wherein the indication comprises haptic feedback.

9. The method of any of examples 1-8 wherein the phone comprises a cellular phone.

10. The method of any of examples 1-9 and further comprising:

detecting voices in the same location as the phone; and

reducing the specified threshold as a function of the detected voices.

11. A machine readable storage device having instructions for execution by a processor of a machine, the instruction comprising instructions to perform:

detecting via the phone, a volume level of a user's voice while using a phone;

detecting a volume level of ambient sound;

comparing the difference between the volume level of the user's voice and the volume level of ambient sound; and

providing an indication to the user when the difference exceeds a specified threshold.

12. The machine readable storage device of example 11 wherein the audible sound comprises a feedback tone and wherein the feedback tone increases in volume with an increase in the difference.

13. The machine readable storage device of any of examples 11-12 and further comprising instructions to perform:

detecting voices in the same location as the phone; and

reducing the specified threshold as a function of the detected voices.

14. A device comprising:

a processor; and

a memory device having a program stored thereon for execution by the processor to:

receive a volume level of a user's voice while using a phone;

receive a volume level of ambient sound;

compare the difference between the volume level of the user's voice and the volume level of ambient sound; and

provide an indication to the user when the difference exceeds a specified threshold.

15. The device of example 14 wherein the indication comprises an audible sound.

16. The device of example 15 wherein the audible sound comprises words.

17. The device of any of examples 15-16 wherein the audible sound comprises a feedback tone.

18. The device of example 17 wherein the feedback tone increases in volume with an increase in the difference.

19. The device of any of examples 15-18 wherein the program is further for execution by the processor to record the user's voice and provide the recorded user's voice back to the user as the audible sound at a volume proportional to the difference in volume between the volume level of the user's voice and the volume level of ambient sound.

20. The method of any of examples 14-19 wherein the program is further for execution by the processor to:

detect voices in the same location as the phone; and

reduce the specified threshold as a function of the detected voices.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
detecting via a computing device with voice capabilities, a volume level of a user's voice while using the computing device with voice capabilities;
comparing via the computing device with voice capabilities whether the volume level of the user's voice exceeds a specified threshold; and
providing an indication to the user via the computing device with voice capabilities when the volume level exceeds the specified threshold.

2. The method of claim 1 and further comprising:
detecting a volume level of ambient sound; and
wherein comparing whether the volume level of the user's voice exceeds a specified threshold includes adding the volume level of ambient sound to the threshold.

3. The method of claim 1 wherein the indication comprises an audible sound.

4. The method of claim 3 wherein the audible sound comprises words.

5. The method of claim 3 wherein the audible sound comprises a feedback tone.

6. The method of claim 5 wherein the feedback tone increases in volume with an increase in the difference.

7. The method of claim 3 and further comprising recording the user's voice and providing the recorded user's voice back to the user as the audible sound at a volume proportional to the difference in volume between the volume level of the user's voice and the volume level of ambient sound.

8. The method of claim 1 wherein the indication comprises haptic feedback.

9. The method of claim 1 wherein the computing device with voice capabilities comprises a cellular phone.

10. The method of claim 1 and further comprising:
detecting voices in the same location as the computing device with voice capabilities; and
reducing the specified threshold as a function of the detected voices.

11. A machine readable storage device having instructions for execution by a processor of a machine, the instruction comprising instructions to perform:
detecting via a computing device with voice capabilities, a volume level of a user's voice while using a computing device with voice capabilities;
detecting a volume level of ambient sound;
comparing the difference between the volume level of the user's voice and the volume level of ambient sound; and
providing an indication to the user when the difference exceeds a specified threshold.

12. The machine readable storage device of claim 11 wherein the audible sound comprises a feedback tone and wherein the feedback tone increases in volume with an increase in the difference.

13. The machine readable storage device of claim 11 and further comprising instructions to perform:
detecting voices in the same location as the computing device with voice capabilities; and
reducing the specified threshold as a function of the detected voices.

14. A device comprising:
a processor; and
a memory device having a program stored thereon for execution by the processor to:
receive a volume level of a user's voice while using the device;
receive a volume level of ambient sound;
compare the difference between the volume level of the user's voice and the volume level of ambient sound; and
provide an indication to the user when the difference exceeds a specified threshold.

15. The device of claim 14 wherein the indication comprises an audible sound.

16. The device of claim 15 wherein the audible sound comprises words.

17. The device of claim 15 wherein the audible sound comprises a feedback tone.

18. The device of claim 17 wherein the feedback tone increases in volume with an increase in the difference.

19. The device of claim 15 wherein the program is further for execution by the processor to record the user's voice and provide the recorded user's voice back to the user as the audible sound at a volume proportional to the difference in volume between the volume level of the user's voice and the volume level of ambient sound.

20. The device of claim 14 wherein the program is further for execution by the processor to:
detect voices in the same location as the device; and
reduce the specified threshold as a function of the detected voices.

21. The device of claim 14 and further comprising a microphone coupled to the processor.

22. The device of claim 14 and further comprising a speaker coupled to the processor.

23. The device of claim 14 and further comprising:
a microphone coupled to the processor; and
a speaker coupled to the processor.
